(19) United States
(12) Patent Application Publication
(10) Pub. No.: US 2026/0285610 A1
(43) Pub. Date: Sep. 24, 2026

(54) TRANSPORT SYSTEM FOR WORKPIECES AND METHOD FOR OPERATING A TRANSPORT SYSTEM

(71) Applicant: HOMAG GMBH, Schopfloch (DE)

(72) Inventors: Rolf HOFBAUER, Gäufelden (DE); Jochen BECK, Horb (DE); Yimin GAN, Rottenburg am Neckar (DE)

(21) Appl. No.: 19/469,997

(22) PCT Filed: Mar. 28, 2024
(86) PCT No.: PCT/EP2024/058605

§ 371 Date: Sep. 26, 2025

(30) Foreign Application Priority Data
Apr. 5, 2023 (DE) 10 2023 108 701.0

(51) Int. Cl. B65G 43/00; B23Q 15/12; G05B 13/02

(52) U.S. Cl. CPC B65G 43/00; B23Q 15/12; G05B 13/0205; B65G 2201/022; B65G 2203/0291; B65G 2203/042; B65G 2207/48; B65G 2811/095

(57) ABSTRACT

Transport system (1) for workpieces (2) preferably consisting at least in parts of wood, wood materials, plastic or the like, said transport system comprising at least one continuously rotating member (10) that is guided by a guide unit (12) in a direction of rotation and comprises at least one support surface (14) for supporting a workpiece (2) to be transported, at least one drive (20) for driving the continuously rotating member (10) at a transport speed in the direction of rotation, a control unit (30) for controlling the at least one drive (20), and at least one sensor (40, 42, 44) for detecting at least one dynamic property of the transport system (1). The control unit (30) is configured to change the transport speed, taking into account a detection result of the at least one sensor (40, 42, 44), such that at least one dynamic property of the transport system (1) is improved, in particular optimised.

### TECHNICAL FIELD

The invention relates to a transport system for workpieces according to the preamble of patent claim 1 and to a method for operating such a transport system.

### PRIOR ART

A transport system of the type mentioned above is disclosed, for example, in WO 2020/229598 A1. Such transport systems are often used for conveying and processing plate-shaped workpieces in the furniture and components industry.

When transporting workpieces, ever greater demands are being placed on both the transport speed as well as on the precision of the transport operation and the resulting quality of the workpieces. The transport speeds are often 80 m/min and more and can also reach 300 m/min, for example. It has been shown that such transport systems can be subject to high levels of wear, which can impair the precision of the transport operation and thus also the quality of the workpieces. This furthermore results in considerable maintenance or repair requirements.

### DESCRIPTION OF THE INVENTION

An object of the invention is to provide a transport system and a transport method of the type mentioned above, which enable a precise transport operation, a high quality of the transported workpieces and a long service life with low maintenance requirements.

According to the invention, this object is solved by means of a transport system according to claim 1 and a method for operating a transport system according to claim 8. Particularly preferred further developments of the invention are specified in the dependent claims.

On the one hand, the invention is based on the realisation that the main cause of high wear of the transport system is dynamic stresses which result from the rotational movement of the continuously rotating member and become increasingly worse as the transport system wears. On the other hand, the inventors have found that even comparatively small changes in the rotational and transport speed of the continuously rotating member can help to reduce the dynamic stresses that occur and thus significantly increase the service life of the overall system.

Against this background, it is provided according to the invention that in a transport system of this type, the control unit is configured to change the transport speed, taking into account a detection result of the at least one sensor, such that at least one dynamic property of the transport system is improved, in particular optimised. The inventors have found that a dramatic improvement in the dynamic behaviour and, in particular, a considerable reduction in vibrations occurring in the transport system can be achieved by a targeted adjustment of the transport speed. This results in significantly reduced wear, but also in a significantly more precise transport operation with a corresponding increase in the quality of the workpieces. It also results in a long service life and low maintenance requirements.

Within the scope of the invention, a wide variety of dynamic properties can be detected in order to achieve the aforementioned objectives. However, it has proven to be particularly effective if, according to a further development of the invention, the dynamic property is selected from vibration of the continuously rotating member, vibration of the support surface and vibration of the guide unit.

According to a further development of the invention, it is additionally provided that the control unit is configured to change the transport speed within a predetermined range, which is preferably adjustable. In this way, it is possible to take into account the conflict between, on the one hand, the desire to optimise the at least one dynamic property as far as possible and, on the other hand, the desire not to change the transport performance of the transport system too much, in particular not to impair it. By providing a range, both requirements can be taken into account, with an adjustable range helping to take into account as precisely as possible the respective requirements that are set, for example, by the operator of the transport device, and to achieve the greatest possible optimisation of the at least one dynamic property within this framework.

It is particularly preferred that the range is at most 40%, preferably at most 20%, of an initial speed prior to change of the transport speed. These ranges have proven to be advantageous in that they allow very extensive optimisation of the at least one dynamic property without the need for excessive changes in transport speed. The range may be both symmetrical and asymmetrical in relation to the initial speed and may, for example, also only allow positive values (increases in transport speed compared to the initial speed). In this way, an improvement in the at least one dynamic property can be combined with an increase in the performance of the transport system.

According to a further development of the invention, it is additionally provided that the control unit is configured to change the tension of the continuously rotating member, taking into account a detection result of the at least one sensor, such that at least one dynamic property of the transport system is improved, in particular optimised. By additionally considering or adjusting the tension of the continuously rotating member, the at least one dynamic property can be improved in a particularly effective manner without having to adjust the transport speed excessively. In this way, the advantages according to the invention as described above are achieved particularly effectively, while at the same time only slight changes need to be made to the overall operation of the transport device.

According to a further development of the invention, at least one sound sensor is furthermore provided, wherein the control unit is configured to change the transport speed and/or tension of the continuously rotating member, taking into account a detection result of the at least one sound sensor, such that at least one dynamic property of the transport system and/or the operating noise of the transport system is improved, in particular optimised. By taking a sound sensor into account, an even finer and more complex improvement of the at least one dynamic property can, on the one hand, be achieved since a sound sensor can detect dynamically relevant information that cannot be fully detected by a vibration sensor, for example. Furthermore, a targeted improvement in the operating noise of the transport system according to the invention can also be achieved.

According to a further development of the invention, a particularly advantageous use of the transport system according to the invention is a processing machine according to claim 7. In such a processing machine, the advantages described above achieve their full effect since such processing machines often require the workpiece to be transported at very high speeds of, for example, 80 m/min up to 200 m/min and more. Such transport speeds can lead to very high dynamic stresses in the transport system, and thus the invention makes a significant contribution to minimising wear, optimising the quality of the workpieces and increasing service life.

A method for operating a transport system according to the invention is defined in claim 8 and serves to realise the aforementioned advantages. It is particularly preferred if the control unit changes the transport speed, taking into account the detection result of the at least one sensor, such that at least one dynamic property of the transport system is improved, in particular optimised.

In addition, a further development of the method according to the invention also allows a measurement run (sweep) to be performed in advance (i.e. before the transport system or a processing machine equipped therewith is actually put into operation) or also at suitable later times by operating the at least one continuously rotating member at a variable speed over a predetermined speed range and detecting, at a plurality of different speeds, one dynamic property of the transport system in each case by means of the at least one sensor. This makes it possible to establish a characteristic curve for the at least one dynamic property as a function of the transport speed of the transport system, which can be used effectively in the further operation of the machine when setting, changing and, if necessary, optimising the transport speed.

According to a further development, it is provided that such a “sweep” can also be performed for different chain tensions in order to enable an even more effective database and, as a result, a more precise adjustment of the overall system. For this purpose, it is provided according to a further development of the invention that after the “sweep” described above, a tension of the at least one continuously rotating member is changed, the at least one circulation member then subsequently being operated at a variable speed over a predetermined speed range and one dynamic property of the transport system being detected in each case at a plurality of different speeds by means of the at least one sensor.

The speed range described above may, in principle, extend over the entire operating speed of the transport system or may also only take into account smaller subsections or ranges. With regard to an effective adjustment of the transport speed, it is, however, provided according to a further development of the invention that the speed range extends over at least 20%, preferably at least 40%, of the maximum speed range of the transport system.

According to a further development of the invention, it is furthermore provided that the values of the at least one dynamic property which are detected over the predetermined speed range are stored in a data memory, in particular a database, together with the corresponding speed values. This allows the control unit to quickly and reliably access the obtained data at any time and thus evaluate an effective adjustment of the transport speed or other parameters.

According to a further development of the invention, it is accordingly provided that the control unit accesses the values of the dynamic property and the corresponding speed stored in the data memory and adjusts the transport speed of the continuously rotating member on the basis thereof.

According to a further development of the invention, it is furthermore provided that the stiffness and/or the weight of the guide unit are adjusted, in particular increased, on the basis of the values of the dynamic property and the corresponding speed stored in the data memory such that at least one dynamic property is improved at a desired transport speed. This further contributes to achieving an improvement in at least one dynamic property with minimal or even no adjustment of the transport speed, such that the aforementioned advantages can be combined with a minimal change in the performance of the transport system.

### BRIEF DESCRIPTION OF THE DRAWINGS

FIG. 1 schematically shows a side view of a processing device with a transport system according to an embodiment of the invention;

FIG. 2 schematically shows a diagram with a vibration amplitude as a function of a transport speed.

### DETAILED DESCRIPTION OF PREFERRED EMBODIMENTS

Preferred embodiments of the invention will be described in detail below with reference to the accompanying figures.

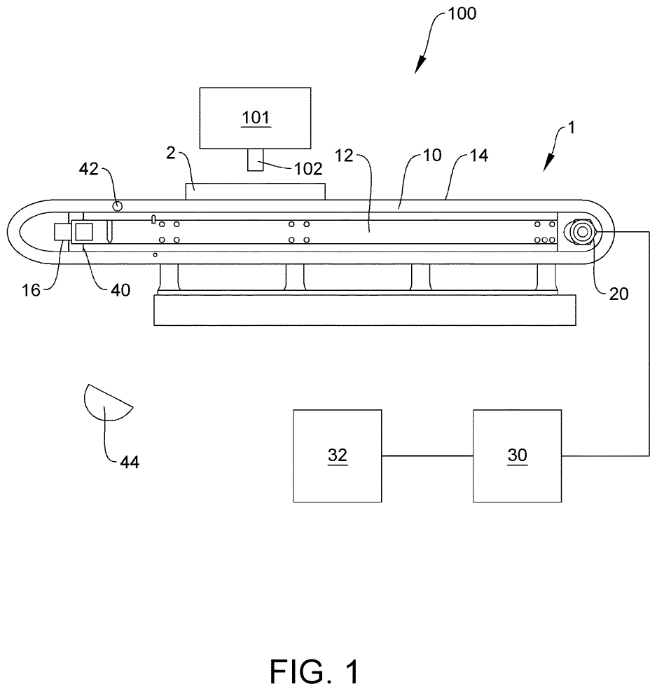

A side view of a processing machine 100 for processing a workpiece 2 is schematically shown in FIG. 1. The processing machine 100 is used to process workpieces 2 that consist entirely or partially of, for example, wood, wood material, plastic or similar materials and material combinations. Inter alia plaster, plasterboard, WPC, SPC and other materials also come into consideration here. Such workpieces are widely used in the furniture and components industry, for example as carcass parts, fronts, doors, etc., but also in the field of interior fittings, for example as wall or floor panels.

The processing machine 100 comprises a processing unit 101 for carrying out the actual workpiece processing. For this purpose, the processing unit 101 may comprise, for example, a processing tool 102 that can carry out machining or other shaping processing, for example. Alternatively or additionally, the processing unit 101 may, however, also be configured for other processing operations, such as coating (e.g. application of a coating material, such as an edge), patterning (e.g. printing) or a variety of other processes that change the shape or appearance of the workpiece 2.

The processing machine 100 furthermore comprises a transport system 1 that serves to move the workpieces 2 to be processed relative to the processing unit 101 or, in general, to bring about a relative movement.

In the present embodiment, the transport system 1 of the processing machine 100 is configured as a continuous transport system and comprises one or more (possibly parallel) continuously rotating members 10, for example in the form of a chain, a belt or the like. The continuously rotating member comprises a support surface 14 on its outer circumference for supporting the respective workpiece 2 to be transported. The support surface 14 may be formed, for example, by suitable plates.

The continuously rotating member 10 is guided by a guide unit 12, which may, for example, comprise a beam carrier and other suitable components. The continuously rotating member can therefore move in a guided manner in a direction of rotation around the guide unit 12 at a transport speed and can be driven for this purpose by a drive 20. The drive 20 is connected to a control unit 30 that controls the drive 20 and, in particular, can set different transport speeds.

In the present embodiment, the transport system 1 furthermore comprises a plurality of sensors 40, 42 and 44 for detecting one or more dynamic properties of the transport system. A vibration sensor 40 is attached to the guide unit 12, a further vibration sensor 42 is attached to the continuously rotating member 10 and a sound sensor 44 is provided at a suitable location in the area of the transport system. The sensors are thus able to detect vibration of the continuously rotating member 10, the support surface 14 and the guide unit 12, and the sound sensor 44 can at least indirectly detect corresponding information as well as the operating noise in general.

Although this is not shown in FIG. 1, the sensors 40, 42, 44 are connected to the control unit 30 such that the detection results of the respective sensors can be transferred to the control unit 30. On the basis thereof, the control unit 30 is configured to change the transport speed of the transport system 1 such that at least one dynamic property of the transport system is improved.

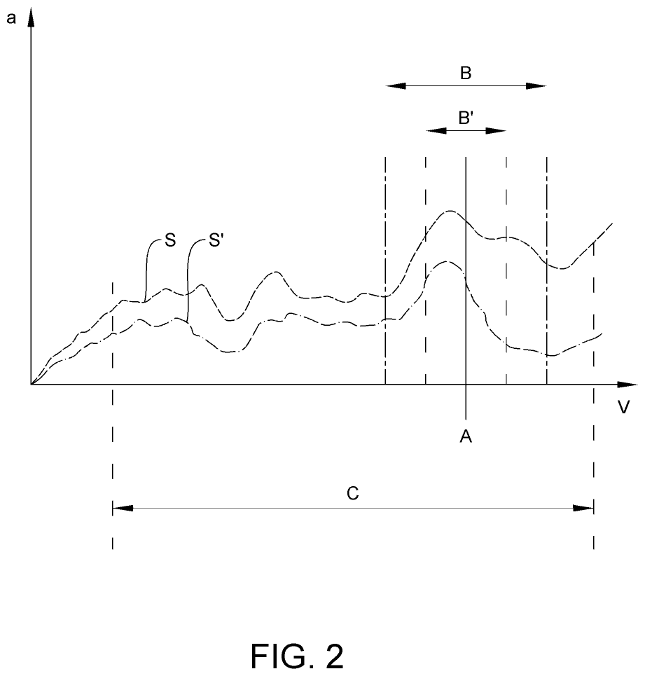

The improvement of the at least one dynamic property can, in principle, be an optimisation over the entire speed range. Furthermore, it is also advantageously possible for the control unit 30 to change the transport speed within a predetermined range B, B', which is illustrated in FIG. 2. FIG. 2 shows, purely schematically, a possible course of a vibration amplitude a as a function of the transport speed v. The vibration amplitude may be, for example, the amplitude of the continuously rotating member 10 or the guide unit 12, as detected, for example, by at least one of the sensors.

It is apparent that the amplitude a is subject to strong fluctuations as the transport speed v increases and has a relatively large value e.g. at an initial speed A that may be intended or desired by an operator of the machine, for example. The invention now provides to change the transport speed such that the amplitude a (or another relevant dynamic property) is improved.

As mentioned above, the control unit 30 can be configured to change the transport speed within a predetermined range relative to the initial speed A. The range may be adjustable, for example to a relatively large range B (e.g. maximum 40% of the initial speed) or to a somewhat smaller range B′ (e.g. maximum 20% of the initial speed).

If a corresponding range has been defined, the control unit is configured to set a transport speed v within the range, at which the dynamic property is as favourable as possible, i.e. in this case the amplitude a is as low as possible. The user or operator of the transport system 1 can also specify, for example, that only increases in speed should be permitted within the range, or that based on certain criteria, reductions in speed should also be permitted, for example if the improvement in the dynamic property can be improved significantly more with a (possibly slight) reduction in the transport speed than with an increase in the transport speed v.

A further parameter in FIG. 2 is the tension of the continuously rotating member, with schematic curves for two different tensions S and S′ being shown in FIG. 2. The curves show that the amplitude course for the two voltages S and S′ is similar in principle, but that within the smaller range B′, for example, a significantly greater reduction in the amplitude a can be achieved for the chain tension S′ than for the tension S. In addition, the amplitude a for the chain tension S′ is generally lower than for the chain tension S. The control unit can take this into account by adjusting the tension of the continuously rotating member 10, taking into account a detection result of one or more of the sensors 40, 42 and 44, such that the amplitude a is reduced or another dynamic property is improved. In order to adjust the chain tension, the transport system 1 may comprise a suitable chain tensioner 16, which is shown schematically in FIG. 1.

The adjustment of the transport speed described above can, in principle, be carried out at any time during the use of the transport system and, if necessary, can also be performed repeatedly, for example if the operating parameters of the transport system have changed (e.g. mass of the workpieces, ambient temperature, wear, etc.). It is furthermore also possible to perform a systematic “sweep” of the transport speed during start-up of the transport system 1 or also at later times, in which the at least one continuously rotating member 10 is operated at a variable speed over a predetermined speed range C (cf. FIG. 2) and one dynamic property of the transport system 1, such as the amplitude a, is detected in each case at a plurality of different speeds by means of one or more of the sensors 40, 42, 44. At least ten, preferably at least 100 or even significantly more measuring points can, for example, be recorded (i.e. measured at a corresponding number of different speeds). The speed range C may extend over the entire speed range of the transport system 1 or may also only extend over a partial range, which should, however, compromise at least 20%, preferably at least 40% of the maximum speed range in order to obtain meaningful results.

The sweep may furthermore also be performed at a plurality of different tensions S and S′ of the continuously rotating member 10 in order to create a corresponding database in this regard too.

The values of the at least one dynamic property and the corresponding speeds recorded in this way are then stored in the data memory 32 shown in FIG. 1 and are thus available to the control unit 30 at any time. The data memory can, in principle, be located anywhere, such as also in the cloud. Furthermore, data from different machines can also be combined and evaluated together in the data memory 32 or a database stored thereon in order to provide corresponding data for the control unit 30.

Another possible way to improve the dynamic properties of the transport system 1 is to change the stiffness and/or weight of the guide unit 12. The data recorded above by the sensors 40, 42 and/or 44 can also form a very good basis for such an optimisation. For example, this data can be incorporated into numerical simulations, on the basis of which it can be determined whether and, if so, which areas of the guide unit can be provided with stiffeners or adjusted in terms of their mass in order to improve the dynamic properties of the transport system.

1. Transport system for workpieces preferably consisting at least in parts of wood, wood materials, plastic or the like, said transport system comprising:
at least one continuously rotating member that is guided by a guide unit in a direction of rotation and comprises at least one support surface for supporting a workpiece to be transported,
at least one drive for driving the continuously rotating member at a transport speed in the direction of rotation,
a control unit for controlling the at least one drive, and
at least one sensor for detecting at least one dynamic property of the transport system.
the control unit being configured to change the transport speed, taking into account a detection result of the at least one sensor, such that at least one dynamic property of the transport system is improved, in particular optimised.

2. The transport system according to claim 1, wherein the dynamic property is selected from vibration of the continuously rotating member, vibration of the support surface and vibration of the guide unit.

3. The transport system according to claim 1, wherein the control unit is configured to change the transport speed within a predetermined range, which is preferably adjustable.

4. The transport system according to claim 3, wherein the range is at most 40%, preferably at most 20%, of an initial speed prior to change of the transport speed.

5. The transport system according to claim 3, wherein the control unit is configured to change the tension of the continuously rotating member, taking into account a detection result of the at least one sensor, such that at least one dynamic property of the transport system is improved, in particular optimised.

6. The transport system according to claim 3, wherein at least one sound sensor is provided, the control unit being configured to change the transport speed and/or tension of the continuously rotating member, taking into account a detection result of the at least one sound sensor, such that at least one dynamic property of the transport system and/or the operating noise of the transport system is improved, in particular optimised.

7. Processing machine for processing a workpiece preferably consisting at least in parts of wood, wood materials, plastic or the like, said processing machine comprising:
a processing unit for processing the workpiece, and
a transport system according to one of the preceding claims for bringing about a relative movement between the processing unit and the workpiece and for supporting the workpiece during processing.

8. Method for operating a transport system according to claim 1, wherein
the at least one continuously rotating member is operated at a predetermined speed,
at least one dynamic property of the transport system is detected by means of the at least one sensor, and
the detection result of the at least one sensor is supplied to the control unit and/or a data memory.

9. The method according to claim 8, wherein the control unit changes the transport speed, taking into account the detection result of the at least one sensor, such that at least one dynamic property of the transport system is improved, in particular optimised.

10. The method according to claim 8, wherein the at least one continuously rotating member is operated at a variable speed over a predetermined speed range and one dynamic property of the transport system is detected in each case at a plurality of different speeds by means of the at least one sensor.

11. The method according to claim 10, wherein a tension of the at least one continuously rotating member is changed, the at least one continuously rotating member then subsequently being operated at a variable speed over a predetermined speed range and one dynamic property of the transport system being detected in each case at a plurality of different speeds by means of the at least one sensor.

12. The method according to claim 10, wherein the speed range extends over at least 20%, preferably at least 40%, of the maximum speed range of the transport system.

13. The method according to claim 10, wherein the values of the at least one dynamic property which are detected over the predetermined speed range are stored in a data memory, in particular a database, together with the corresponding speed values.

14. The method according to claim 13, wherein the control unit accesses the values of the dynamic property and the corresponding speed stored in the data memory and adjusts the transport speed of the continuously rotating member on the basis thereof.

15. The method according to claim 10, wherein the stiffness and/or the weight of the guide unit are adjusted, in particular increased, on the basis of the values of the dynamic property and the corresponding speed stored in the data memory such that at least one dynamic property is improved at a desired transport speed.
